(19) United States
(12) Patent Application Publication
(10) Pub. No.: US 2025/0370472 A1
(43) Pub. Date: Dec. 4, 2025

(54) Perception-Based Navigation for Mobile Machines

(71) Applicant: Caterpillar Inc., Peoria, IL (US)

(72) Inventor: Michael D. Braunstein, Washington, IL (US)

(73) Assignee: Caterpillar Inc., Peoria, IL (US)

(21) Appl. No.: 18/678,472

(22) Filed: May 30, 2024

(51) Int. Cl. G05D 1/639; G05D 1/246; G05D 107/90

(52) U.S. Cl. CPC G05D 1/639; G05D 1/246; G05D 2107/90

(57) ABSTRACT

To assist operation of a perception-based location and navigation system, a computer-implemented system and method can determine if a physical marker at a worksite is perceptibly obstructed. Worksite data can be gathered from the physical worksite and/or a worksite map in computer readable format. The worksite data is analyzed with respect to the worksite map to determine if the physical marker is obstructed. To resolve the marker obstruction, an obstruction resolution can be generated and output.

### TECHNICAL FIELD

This patent disclosure relates generally to the management and coordination of mobile machines about a worksite and, more particularly, to a system and method for assisting in the perception-based navigation of a plurality of mobile machines at the worksite.

### BACKGROUND

The development of large-scale worksites, such as in mining or construction,, involves the communication and coordination of information about the worksite between the personnel and mobile machines that are performing activities or tasks at the worksite. A variety of different mobile machines need to move to different locations about the worksite to conduct different assigned tasks. For example, to haul material, haul machines such as haul trucks used in mining are off road, large scale mobile machines specifically designed for transporting significant quantities of material, e.g., several tons, about the worksite. Other examples of mobile machines include dozers, loaders, excavators, graders, scrapers, etc. The plurality of mobile machines may be configured for manual operation with an onboard operator controlling the machine, remote control, semi-autonomous, or autonomous operation.

To assist in travel and navigation of the mobile machines about the worksite, the machines may be associated with a perception-based localization and navigation system that utilizes machine vision and object detection technologies. For example, perception sensors and rangefinders located on a mobile machine can sense the location and proximity of the machine with respect to other objects and landmarks at the worksite. The objects may be artificial structures like markers and flags placed about the worksite at appropriate locations, or may be geographic features such as berms, rocks, tree lines, etc. The locations of the markers may be stored and tracked using a computer-readable worksite map that can be communicated between the plurality of mobile machines and other computer and communications systems associated with the worksite and that can be visibly displayed on a display screen.

U.S. Pat. No. 9,142,063 describes the development and maintenance of an electronic object map that stores the geographic positions and information about objects detected in the worksite. The electronic object map can be generated and maintained locally onboard the mobile machine, or may be a preloaded map with a priori information about the physical worksite obtained from previously gathered survey data maintained and processed by an off-board computer system. The mobile machines utilize the electronic object map and the detection data obtained by the perception-based localization and navigation system for the positioning and navigation about the physical worksite.

If the perception-based localization and navigation system encounters issues with detecting objects in the environment, localization and navigation of the mobile machine may be effected. For example, the mobile machine may incorrectly determine its location within the worksite, or in the example of autonomous operation, the mobile machine may cease further operation until the object detection issues are resolved. Object detection can be negatively affected by numerous different causes including environmental factors and activities occurring at the worksite. Relatedly, possible resolutions for resolving object detection issues are likewise numerous.

The present disclosure is directed to improvements in identifying and resolving object detection issues that may occur with perception-based navigation technologies and computer-readable object maps

### SUMMARY

The disclosure describes, in one aspect, a computer-implement analytic map processor that includes a marker identification module to identify an assigned marker position in a worksite map in a computer readable format and a data gathering module to obtain worksite data. A detection module of the analytic map processor analyzes the worksite data with respect to the assigned marker position to determine if a marker obstruction has occurred that perceptibly obstructs a physical marker. The analytic map processor may include an obstruction resolution module configured to determine and output an obstruction resolution in response to the marker obstruction.

In another aspect, the disclosure describes a computer-implemented method for detecting and resolving a marker obstruction of a physical marker at a physical worksite. The method involves identifying an assigned marker position in a worksite map in a computer-readable format and obtaining worksite data from one or more of the physical worksite and the worksite map. The worksite data and the worksite map are analyzed to determine if a mark obstruction has occurred that perceptibly obstructs the physical marker. The method may also generate an obstruction resolution to resolve the marker obstruction.

In yet another aspect, the disclosure describes an onboard electronic controller associated with a mobile machine operating at a physical worksite configured with a perception-based localization and navigation system. The onboard electronic controller includes memory that stores a worksite map in computer-readable format with an assigned marker position. The onboard electronic controller also includes a data gathering module configured to obtain worksite data from one or more of the physical worksite and the worksite map. The onboard electronic includes a detection module to analyze the worksite map and the worksite data to determine if a physical marker in the physical worksite is perceptibly obstructed.

### BRIEF DESCRIPTION OF THE DRAWINGS

FIG. 1 is a schematic illustration of a worksite such as a mine or quarry having a plurality of mobile machines cooperatively operating with a perception-based localization and navigation system implemented in accordance with the disclosure.

FIG. 2 is schematic block diagram of the components and features of a computerized system for generating and using a computer-readable map of the worksite for the perception-based localization and navigation system.

FIG. 3 is a flow diagram of the possible features and operations of a computerized method for determining if a physical marker in the worksite may be visibly obstructed and for responding to the marker obstruction.

FIG. 4 is a flow diagram of the possible features and operations for evaluating and responding in the field to an obstruction response.

FIG. 5 is a flow diagram of the possible features and operations of another embodiment of a computerized method operating in cooperation with the onboard perception-based localization and navigation system to determine if a physical marker is visibly obstructed.

### DETAILED DESCRIPTION

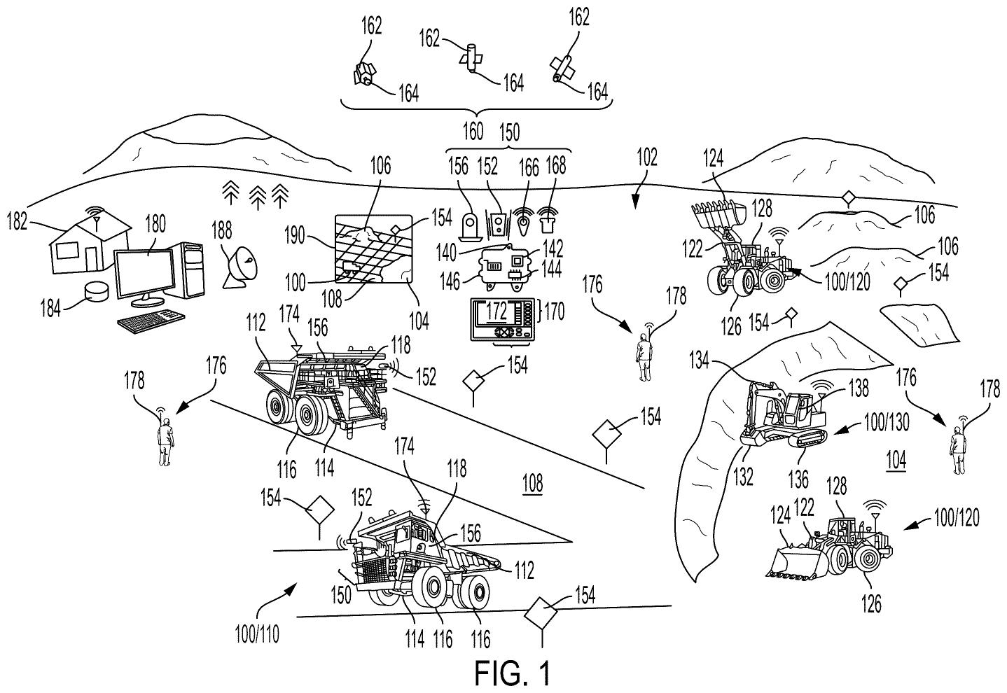

Now referring to the drawings, wherein whenever possible like reference numbers will refer to like elements, there is illustrated in FIG. 1 a plurality of mobile machines 100 operating at worksite 102 such as a mine or a quarry for extraction, processing, and distribution of mined material such as coal, ore, minerals, construction aggregate, and the like. However, aspects of the disclosure may be applicable to other types of worksites 102 where coordinated activities are simultaneously occurring, including large-scale construction sites, agricultural sites, and the like. The worksite 102 is characterized by its terrain or geographic topology, by the presence of structures and equipment to develop the worksite, by activities and/or operations occurring at the worksite, which may be referred to as worksite features. A “worksite feature” refers to a characteristic or attribute of the worksite.

For example, the worksite features may be associated with the various different operations, tasks, and processes conducted at different locations, or operation sites, in the worksite 102. For example, to obtain the raw materials, the worksite 102 may be associated with one or more excavation sites 104, such as above ground or below ground mines, which are the physical locations where the raw materials are excavated from the ground. The excavation site 104 may be an open-pit or open cast surface mine in which the overburden (vegetation, dirt, and the like) is stripped away and removed to access the raw materials underneath. The raw materials may be separated from the ground by drilling, hammering, or blasting operations and removed from the excavation site 104. In other examples, the excavation site 104 may be a subsurface or underground mine in which tunnels are dug into the earth to access the raw materials.

The separated materials may be temporally deposited in one or more material piles 106 located at different places about the worksite 102. The material piles 106 are operation sites associated with loading and dumping operations that may be performed by the mobile machines 100. Other examples of operations that may occur at different locations about the worksite 102 can include construction locations, clearing or leveling operations, harvesting, etc. In addition to different operations, examples of other worksite features that may characterize the worksite 102 can include buildings and structures, natural stationary objects such as hills, mountains, berms, ravines, wooded areas, and any features that are present and characterize the terrain and geographic topography of the worksite 102.

For example, a common feature at mines and similar worksites 102 is the presence of travel routes 108 or haul paths to enable the mobile machines 100 to travel between the various operations such as the excavation site 104, material piles 106, material processing stations such as, for example, crushers. Because of the ongoing activities and unfinished nature of the worksite 102, the travel routes 108 are typically unpaved and comprise paths of compacted carthen materials to support movement of the mobile machines 100, although some portions may be paved and comprise structures like bridges, designated lanes, and the like. The travel routes 108 can be designed to efficiently and expeditiously direct the mobile machines 100 around the worksite 102 and avoid obstacles, hazards, and other critical areas.

Among the plurality of mobile machines 100, haul trucks or haul machines 110 are particularly suited for the transportation of material about the worksite 102. Off-road hauling machines 110 can include a hauling body 112, which may be a dump body, into which material may be loaded. The hauling body 112 can be hinged to a machine frame 114 and can be articulated to dump material at a designated location. The machine frame 114 can be supported on a plurality of wheels 116 to propel and move about the worksite 102. To power propulsion by rotation of the wheels 116, the hauling machine 110 can include a power source or power plant such as an internal combustion engine for the combustion of hydrocarbon-based fuels to convert the latent chemical energy therein to motive power; although other examples of suitable power sources include electric motors associated with rechargeable batteries or fuel cells.

To accommodate an onboard operator, the hauling machine 110 can include an onboard operator station 118, which may be an enclosed space situated on the machine frame 114 at a location to provide visibility about the worksite 102. Located in the operator station 118 can be various machine controls and operator interfaces, such as steering, speed, and direction controls, through which the operator controls operation of the haul machine 110. The operator interfaces can be embodied as levers, joysticks, steering wheels, pedals, dials, buttons, switches, and the like. Operator interfaces may also include visual displays and readouts to convey information with the operator. In accordance with the disclosure and described below, the haul machines 110 may also be configured for autonomous or semi-autonomous operation, or may be remotely controlled by an offboard operator using a remote control transmitter.

To sustain the rugged operating conditions about the worksite 102, the hauling machine 110 may be designed for off-road operation and may be characterized by its ability to travel over unpaved or unfinished, often rugged, surfaces or surfaces that are often configured for heavy duty or hazardous operating conditions. Further, the off-road hauling machine 110 can be configured to accommodate the significant material quantities involved in a mining operation with the volumetric capacity of the haul body 112 sized to accommodate several tons. Another example of hauling machines 110 that may operate at the worksite 102 can be on-road trucks, characterized by their ability for long-distance travel on paved surfaces and roadways.

To load material to the hauling machines 110, one or more loading machines 120 in the embodiment of a bucket loader, underground haulers, load-dump machines, etc., can also operate about the worksite 102. The loading machine 120 can include a lifting implement 122 with an attached bucket 124 shaped as an opened trough to receive material. The lifting implement 122 can be raised and lowered to move material from the material piles 106 and deliver it the hauling machine 110. The loading machine 120 can be supported on a plurality of wheels 126 for movement between the material piles 106 and haul machines 110 and may be powered by an internal combustion engine or an electrical power source. To accommodate an onboard operator, the loading machine 120 can also include an operator station 128 in which machine controls and operator interfaces are located, although in some examples, operational activities of the loading machine 120 can be automated or remotely controlled.

To dislodge and separate material from the worksite 102, another example of a mobile machine 100 can be an excavator 130 that includes a bucket 132 disposed at the end of another mechanical lift implement 134 that can articulate in various directions to maneuver the bucket. The lift implement 134 can be a mechanical linkage including a boom, a dipper, and a stick pivotally connected to each other. In addition to digging and excavating the material, excavators 130 can be used for loading haul machines 110, demolishing structures or obstacles, and the like. Typically, the excavator 130 can be operatively supported on a plurality of ground-engaging traction devices like continuous tracks 136 through a rotatable platform or undercarriage that rotates to swing the bucket 132 and lift implement 134 about the vertical axis of the excavator. To accommodate an onboard operator, the excavator 130 can also include an operator station 138 that is rotatably supported on the continuous tracks 136, although in some examples, operational activities of the loading machine 120 can be automated or remotely controlled. Other types of excavation machines can include rope shovels, hydraulic mining shovels, etc.

In addition to the foregoing examples, other types of mobile machines 100 may conduct material handling and transportation operations at the different operation sites about the worksite 102. For example, dozers may include a forward mounted blade elevated to push material over the surface of the worksite 102 and tankers can be used for carrying water or fuel about the worksite. As used herein, the term “machine” refers to any type of machine that performs some operation associated with an industry such as mining, construction, farming, transportation, or any other industry known in the art.

The mobile machines 100 described herein can be operated manually, autonomously, or semi-autonomously. During conventional manual operation, an onboard operator controls and directs essentially all the functions and activities of the machine using the controls in the operator station described above. Remote operation may also occur remotely wherein the operator is located off board the mobile machine 100 and operation is controlled through a remote control transmitter and wireless communication techniques.

In autonomous operation, the mobile machine 100 can operate responsively to information about the operating and environmental conditions of the worksite 102 provided from various sensors by selecting and executing various determined responses to the received information. Autonomous mobile machines 100 include a computerized control system comprising hardware and software configured to make independent decisions based on programmed rules and logic. The control system uses sensor input about the machine environment, visions systems, etc., to control propulsion and steering in accordance with guidance controls, worksite or haul route information, and the assigned task or operations. In semi-autonomous operation, an operator either onboard or working remotely may conduct some tasks and operations, while others are conducted automatically in response to information received from sensors. In all examples, positioning information to determine the location and/or positon of the machine is necessary.

In any of the above examples, to assist in operation of the mobile machine 100, the mobile machines 100 can be operatively associated with an onboard electronic controller 140. The onboard electronic controller 140 can be a programmable computing device and can include one or more microprocessors 142 for executing software instructions and processing computer readable data. Examples of suitable microprocessors include programmable logic devices such as field programmable gate arrays (“FPGA”), dedicated or customized logic devices such as application specific integrated circuits (“ASIC”), gate arrays, a complex programmable logic device, or any other suitable type of circuitry or microchip.

To store application software and data, the onboard electronic controller 140 can include a non-transitory computer readable and/or writeable data memory 144 or similar data storage that can be embodied, for example, as read only memory (“ROM”), random access memory (“RAM”), EPROM memory, flash memory, or etc. Data memory 144 can also be operatively associated with and utilize more permanent forms of secondary data storage such as magnetic hard drives. The data memory 144 is capable of storing software in the form of computer executable programs including instructions, definitions, and electronic data for the operation of the mobile machine. The programs can include equations, algorithms, charts, maps, lookup tables, databases, and the like.

To interface and network with the other components and operational systems on the mobile machine 100, the onboard electronic controller 140 can include an input/output interface 146 to electronically send and receive non-transitory data and information. The input/output interface 146 can be physically embodied as data ports, serial ports, parallel ports, USB ports, jacks, and the like to communicate via conductive wires, cables, optical fibers, or other communicative components that may be part of a communication bus or otherwise networked. The input/output interface 146 can communicatively transmit data and information embodied as electronic signals or pulses through physical transmission media such as conductive wires or as optical pulses through fiber optics. Communication can also occur wirelessly through the transmission of radio frequency signals. Communication can occur via any suitable communication protocol for data communication including sending and receiving digital or analog signals synchronously, asynchronously, or elsewise.

To assist with the navigation and travel of the mobile machine 100 about the worksite 102, the onboard electronic controller 140 can be operatively associated with and functionally implement a perception-based localization and navigation system 150 that utilizes various object perception and detection technologies and related devices, which as described below may work in combination with other positioning/navigation systems. The perception-based localization and navigation system 150 obtains observable information about objects externally located in the surrounding environment of the physical worksite 102 and processes that information to determine the geographic position of the mobile machine 100. The perception-based localization and navigation system 150 can function by detecting various markers, obstacles, and/or objects whose location/positions are previously known, for example, from a survey map of such objects. In an embodiment described herein, artificial markers may be located about the worksite for detection. In other embodiments, other features at the worksite available for detection may include geographic developments resulting from worksite operations like the material piles 106, stationary and artificial objects like buildings and structures, and possibly mobile objects such as other mobile machines. The perception-based localization and navigation system 150 further combines the obtained environmental information with other operational data about the mobile machine 100 to responsively control and navigate operation of the mobile machine in accordance with a determined task. The geographic location, geographic position or orientation, speed, velocity, travel direction and travel distance are examples of parameters that may be used to assist in navigation of the mobile machine 100.

The perception-based localization and navigation system 150 can obtain and capture perceptible data about structures and objects about the worksite 102 that the onboard electronic controller 140 can process and appropriately respond to. The perception data can include information such as distances, ranges, dimensional sizes and shapes, features, orientations, etc. By sequentially or repetitively capturing perception data, the onboard electronic controller 140 can also discern motion and movement information including speed and direction of moving objects or physical changes to the terrain and topology of the worksite 102 over time.

To obtain and provide data and information about objects, conditions, and activities in the physical worksite 102, the perception-based localization and navigation system 150 can include object detection devices. An example of an object perception device can be a LIDAR sensor or LIDAR device 152. The LIDAR (light detection and ranging) device 152 includes a light source or emitter that projects a laser or light beam that impinges upon and is reflected by material objects. The reflected light can be captured by a detector associated with the LIDAR device 152 and the elapsed time between projection and return of the light, and other characteristics of the reflected light such as intensity, can be processed and analyzed for ascertaining visual and definitional information regarding the reflecting object or terrain such as distance, size, shape, etc.

The perception data captured by the LIDAR device 152 can be recorded as a point cloud comprised of a plurality of individual reflected points produced by rapid projections from the light source. The plurality of individual points of the point cloud are plotted in an array having defined coordinates for geometric location. The combined characteristics of the individual points, such as intensity, provide a visual image detailing the three dimensional shape and dimensions of the scanned objects and background. The perception data creating the point cloud can be stored and transmitted as a computer readable image data file that the onboard electronic controller 140 can process. The LIDAR device 152 can be communicatively connected to and networked with the input/output interface 146 to send the image data files to the onboard electronic controller 140.

The LIDAR device 152 can be mounted on the machine frame 114 of, for example, the haul machine 110 to establish visibility over the worksite 102. The LIDAR device 152 can be rotated with respect to the machine frame 114 to capture wider visual angles or sweeps during scanning. To increase the captured visual area, multiple LIDAR devices 152 can be mounted to the machine frame 114, for example, at the front and rear ends of the haul machines 110.

To serve as a target for the LIDAR device 152, a plurality of visually perceptible, physical markers 154 can be placed about the physical worksite 102. In an embodiment, the physical markers 154 can be artificial structures of a defined shape and size that can reflect the laser or light beam projected from the LIDAR device. For example, the physical markers 154 can be planar diamond shaped plates that provide a two dimensional (X-Y) area that provides a defined shape that is readily recognizable by the LIDAR device 152. The physical marker 154 can be made from sheet metal and can be sized and colored for reflectivity and to enhance visibility, for example, approximately 2 meters by 2 meters in size and brightly painted. The physical markers 154 may have other shapes and configurations to render them prominent and conspicuous about the worksite 102. The physical markers 154 can include visual characters such as text, caricatures, and geometric patterns to convey comprehensible information to observers about the worksite 102 and associated with the location of the physical marker. In some embodiments, the physical markers 154 may also be associated with natural landmarks and features that can be visually detected and are recognizable by the LIDAR device 152. Physical markers 154 can be mounted via a bracket to a pole, to a stationary or movable platform, or to a structure that is fixed and stationary.

Other types of objects can function as physical markers. For example, tires or artificial or natural structures may be detectable by the LIDAR device, smart camera or other detection and the perception-based localization and navigation system 150 may be configured to recognize those objects as physical markers 154.

The physical markers 154 can be positioned to designate features and landmarks about the worksite 102. For example, because the off-road travel routes 108 may be difficult to visually discern from the surrounding terrain, physical markers 154 can be placed along the sides of travel routes 108 and function as navigation guides or wayfinders for the traveling mobile machines 100. The physical markers 154 can also be used to designate operation sites such as the excavation site 104 or the material piles 106, and may include visual characteristics or symbols to convey comprehensible information about or associated with the worksite location. To elevate the physical marker 154 above the terrain surface of the worksite 102 and enhance visibility, the planar panel can be mounted to a post that can be planted into the ground. The physical marker 154 can also be mounted to other natural or artificial objects such as trees, fences, equipment, etc., at the worksite 102 or, as indicated, the physical markers 154 may be associated with recognizable natural features and landmarks. In some embodiments, the physical markers 154 may be mounted to structural features like buildings, equipment, and the like.

In some embodiments, the physical markers 154 may also be associated with natural landmarks and features that can be visually detected and are recognizable by the LIDAR device 152. For example, formations like hills, berms, and rock formations, which may be relatively fixed within the worksite 102, may have distinctive features that are detectable by the perception-based localization and navigation system 150 and can therefore function as a recognizable detection target. Physical markers 154 can also be painted onto structural features or natural landmarks.

In another embodiment, the perception device can be a smart camera 156 that is mounted to the mobile machine 100. A smart camera 156 can be a machine vision system that can capture visual perception data embodied as visual digital images from its field of view and can include data analysis and processing capabilities to extract contextual and relational information regarding the perception data. The smart camera 156 can be programmed to specifically search for, recognize and/or identify the physical marker 154, which maybe distinctly shaped and colored to enhance perceptibility. The smart camera 156 can include automated autofocus, pan, and zoom functions to improve operation. The smart camera 156 can capture individual stationary images or continuous video that may be stored as a computer readable and transmissible image data file. The smart camera 156 can also be mounted to the machine frame 114 of the haul machine 110 to establish a field of view over the worksite 102. The perception-based localization and navigation system 150 can use a combination of LIDAR devices 152 and smart cameras 156.

In another embodiment, the perception system can make use of a different technology, for example, acoustic or radio frequency waves like radar. Similar to LIDAR, radar uses the transmission and reflection of radio waves by an object to determine its location, distance, geometry, and orientation with respect to a receiver, which can be interpreted to visualize objects such as mobile machines 100 and the associated activities within the surrounding worksite 102. The physical marker 154 can be physically shaped and contoured, and can be made of a material that is highly reflective of radio and/or acoustic waves.

To provide additional referential information, the perception-based localization and navigation system 150 can be operatively associated with a position/navigation system 160 that is configured to determine a current position of the mobile machine 100 at the worksite 102. The position/navigation system 160 can be realized as a global navigation satellite system (GNSS) or global positioning satellite (GPS) system. In the GNSS or GPS system, a plurality of manmade satellites 162 orbit about the earth at fixed or precise trajectories. Each satellite 162 includes a positioning transmitter 164 that transmits positioning signals encoding time and positioning information towards earth. By calculating, such as by triangulation, between the positioning signals received from different satellites, one can determine their instantaneous location on earth.

To receive the satellite transmissions, positioning receivers 166 are located on each of the plurality of mobile machines 100. The positioning receivers 166 are antennas sensitive to the positioning signals and convert those signals to electrical signals the onboard electronic controller 140 can process. The positioning receivers 166 are mounted for adequate reception on the mobile machines 100 such as near the top of the machine frame. In an embodiment, the positioning receivers 166 can include two spaced-apart receivers that enables the position/navigation system 160 to determine angular orientation of the mobile machine 100 at the worksite 102 in addition to geographic location.

The position/navigation system 160 may also be configured as a laser based system in which a plurality of laser transmitters are located about the worksite. The laser transmitters transmit laser light that can be sensed by optical sensors on the mobile machines 100. If the precise location of the laser transmitters is known, it can be appreciated that the actual position of the mobile machine within the physical worksite can be determined. Such determination can be conducted based upon, as examples, the Doppler effect of the laser light or time periods between laser incidents on the transmitter/receivers.

To provide additional information and data for use by the perception-based localization and navigation system 150, the mobile machine 100 can include one or more machine sensors 168 that are in data communication with the onboard electronic controller 140. The machine sensors 168 can be any device for detecting or measuring a physical condition or change therein and outputting data representative of that occurrence. The machine sensors 168 can work on any suitable operating principle for the assigned task, and may make mechanical, electrical, visual, and/or chemical measurements.

For example, the machine sensors 168 can be configured to measure or sense the operational condition or situation associated with the mobile machine 100. The operational situations may indicate if the mobile machine 100 is moving or stationary, and whether the mobile machine is undertaking a task or operation with respect to the worksite 102. The machine sensors 168 can determine the operational situation of the mobile machine 100 directly or indirectly, for example, by measuring output of a power plant in terms of torque or engine speed, or odometer data indicative of travel speed or velocity. The machine sensors 168 can operate in cooperation with the perception detectors of the perception-based localization and navigation system 150 to sense the local activities proximate to the mobile machine 100, such as ongoing material loading, dumping, and/or excavating operations.

In some embodiments, the machines sensors 168 can also be engine sensors associated with the power source or engine of the mobile machine 100, or transmission or other powertrain component, and can measure engine output in terms of torque or engine speed. The machine sensors 168 include steering sensors to determine the travel direction of the mobile machine 100. Other examples of machine sensors 168 can include hydraulic pressure sensors that can obtain load or operational information from hydraulic actuators.

To interface with the operator, the onboard electronic controller 140 can be associated with a human machine interface (HMI) 170 that can be located in the operator station 118 of, for example, the mobile hauling machines 110. The HMI 170 can include a visual display screen 172 to visually present information to a human operator regarding operation of the mobile machine 100. The visual display screen 172 can be a liquid crystal display (“LCD”) capable of presenting numerical values, text descriptors, graphics, graphs, charts and the like regarding operation. The visual display screen 172 may have touch screen capabilities to receive input from a human operator. Furthermore, the HMI 170 can include other interface input devices such as dials, knobs, switches, keypads, keyboards, mice, printers, etc.

To communicate and coordinate with other mobile machines 100 at the worksite 102, a transceiver 174 can be mounted to each of the mobile machines at an accessible location. The transceiver 174 can be configured for wireless communications and can send and receive wireless data transmissions using any suitable communication protocol such as WiFi. The transceiver 174 can be operatively connected to the onboard electronic controller 140.

In addition to communicating with other mobile machines 100, the machine transceivers 174 can communicate with personnel 176 moving about the physical worksite 102. The personnel 176 can carry portable personnel transceivers 178 that also are able to send and receive wireless data transmissions. The personnel transceiver 178 can be functionally associated with an interface similar to HMI 170 to display visual information about the activities at the worksite 102 and to receive input from the personnel 176.

To coordinate operation among the plurality of mobile machines 100 and personnel 176, a central worksite server 180 can be located offboard and can be remotely located at a stationary facility or building structure 182 at the worksite 102 or elsewhere. The worksite server 180 can be maintained by the operator of the worksite 102 or can be contracted to an independent application service provider (ASP).

The worksite server 180 includes computer hardware and software that provides functionality and resources supporting the ongoing operations and activities at the worksite 102. The worksite server 180 can host software applications and programming and can provide supplemental processing capabilities that can be accessed and used by other computing systems at the worksite 102. The worksite server 180 can serve as a central network node for communications and can function as a central repository for collection of data. The worksite server 180 can control access to worksite data and computational resources utilized by other systems with which it is networked. The worksite server 180 can administer and manage assignments and tasks related to worksite activities and operations to the plurality of mobile machines 100 and other equipment. The worksite server 180 can also be configured and programmed to identify operational errors and faults and to resolve such problems and discrepancies. The worksite server 180 can function as the control center for the worksite 102.

The worksite server 180 can include one or more microprocessors for the execution of software applications and computer programs and the processing of digital data. To interface with worksite personnel, the worksite server 180 can include data entry terminals and peripherals such as display monitors and keyboards for the entry and presentation of data. Although the worksite server 180 is illustrated as a single standalone unit at a single location, the hardware and functionality may be distributed among different devices at multiple locations.

The worksite server 180 can include a data storage 184 that contains and maintains computer readable data about the operations and activities of the worksite 102 including the plurality of mobile machines 100. The data storage 184 can log and store data about the plurality of mobile machines 100 such as the identities, geographic locations, functional capabilities, and assigned tasks. The data storage 184 can maintain a data table or log about the mobile machines and an electronic worksite map which may be a computer generated virtual representation about the worksite including geographical or topographical features such as terrain conditions, elevations, conditions, structures, objects, landmarks, etc.

To communicate with the plurality of mobile machines 100 and the worksite personnel 176 via the machine transceivers 174 and personnel transceivers 178, the worksite server 180 can be operatively associated with a telematics system 188. The telematics system 188 can broadcast and receive wireless communications through radio waves about the worksite over sufficient distances to cover the worksite. The telematics system 188 can use any suitable wireless protocol or standard such as Wi-Fi.

The worksite server 180 can be responsible for generating and maintaining an electronic worksite map 190 that can be a virtual, computer-readable representation of the worksite 102 that can be rendered on a visual display system. Embodied as a data file, the electronic worksite map 190 can be stored and communicated electronically between computer systems networked to and associated with the worksite server 180. The electronic worksite map 190 may be in two dimensions (X-Y) or three-dimensions (X-Y-Z) and can depict the geography and topology of the worksite 102. The electronic worksite map 190 can be referenced to a coordinate system such as a Cartesian or Euclidian reference system and can be produced at a reduced scale to represent distances and elevations of the worksite topology. The electronic worksite map 190 and can incorporate and depict the various worksite features characterizing the worksite including, for example, the excavation site 104, material piles 106, and travel routes 108.

As the physical worksite 102 develops, the worksite features including the geography and topology characterizing the worksite can change. The electronic worksite map 190 can be dynamic and represent changes and modifications of the worksite features with respect to time. To make changes and updates, information may be communicated to the central worksite server 180 via the telematics system 188 from, for example, the mobile machines 100 operating at the worksite 102. The electronic nature of the electronic worksite map 190 enables dynamic and automatic updates of the worksite features.

In addition to the worksite features, the electronic worksite map 190 can also designate and track the location of the plurality of mobile machines 100 and/or the worksite personnel 176 using electronic designations. The designations in the electronic worksite map 190 can include information about the corresponding machines including identification, operating capabilities, assigned tasks, etc. The designations may also include identification of personnel, their activities within the worksite, etc. Because the central worksite server 180 is in electronic communication via the telematics system 188 with the plurality of mobile machines 100 and the worksite personnel 176, the central worksite server 180 can receive updated and current location data from the mobile machines and personnel moving about the worksite 102 as determined by the position/navigation system 160.

The electronic worksite map 190 can also designate the location and/or orientation of the physical markers 154 placed around the worksite 102. As part of the layout of the worksite 102, the physical markers 154 are placed by worksite personnel 176 at predesignated locations that can be recorded and represented in the electronic worksite map 190 as assigned marker positions. The assigned marker positions can include information about the corresponding physical marker 154, such as its identification, meaning, or duration at its present location.

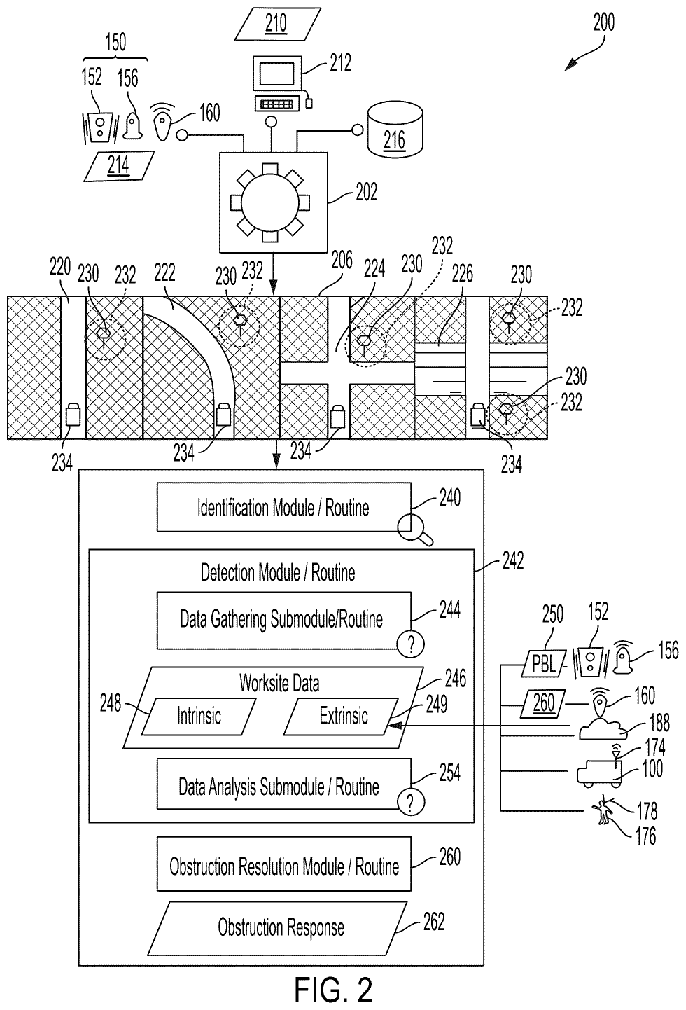

To generate and utilize the electronic worksite map, a mapping application 200 embodied as computer executable software code can be operatively associated with and installed on the onboard electronic controllers 140 and/or the central server 180. Shown schematically in FIG. 2, the mapping application 200 can be comprised of software routines and modules that organize and arrange the processing functions and operations in an executable sequence. The routines and modules may be callable components of the mapping application 200 that can be separately invoked when appropriate. The routines and modules can be configured to interface and exchange data with other systems and programs, for example, by defining data types and data structures, and can include implementation functionality to process the exchanged data. The routines, modules, and functionality of the mapping application 200 can be distributed between the central worksite server 180, the onboard electronic controllers 140, and other computer systems and devices operating about the worksite 102.

For example, in an embodiment, the mapping application 200 can include a map generator 202 and an analytic map processor 204 embodied as programming routines or modules. The map generator 202 can be responsible for creating one or more versions or embodiments of a computer-readable worksite map 206 having visual, digital representations of various worksite features 208, and the analytic map processor 204 can receive and process the worksite map 206 for different purposes. Although FIG. 2 shows the functionality of the mapping application 200 as conceptually distinguished between the map generator 202 and the analytic map processor 204, it should be appreciated that functionality and specific operations can be distributed and shared. Moreover, because the dynamic nature of the computer-readable worksite map 206, the operations of the map generator 202 and analytic map processor 204 may occur in different temporal or sequential orders.

To create the worksite map 206, the map generator 202 can receive survey data 210 that is collected about the physical worksite 102. The survey data 210 can include information about the geography and terrain of the physical worksite 102 including locations, positions, elevations and other spatial or dimensional data about the various worksite features 208. The worksite features 208 may include preexisting objects and elements, such as natural occurring landmarks or artificial structures, and may be combined with data about current or intended operations and activities at the worksite 102. The survey data 210 can be obtained by worksite personnel using conventional surveying techniques and equipment to measure distances and orientations of the different worksite features 208 for representation in the computer-readable worksite map 206. As the worksite 102 develops and the topography changes, the survey data 210 can be updated.

In an embodiment, the map generator 202 can create an initial version of the worksite map 206 using the survey data 210 obtained prior to or during development of the physical worksite 102. The map generator 202 can be located or reside on the central worksite server 180 or another computer system serving as a central repository for the survey data 210. To enter the survey data 210 to the map generator 202 as computer readable and executable input, the map generator can be associated with one or more data entry terminals 212 with peripheral data input devices such as keyboards, mice, etc. Worksite personnel can make modifications, additions, or adjustments to the survey data to add exclusion zones or control zones, identify or verify worksite features, etc.

In another embodiment, the map generator 202 may supplement or update the survey data 210 with perception data and information 214 obtained from the perception-based localization and navigation systems 150 associated with the mobile machines 100. For example, the perception-based localization and navigation system 150 can capture and process visual or other perception data and information 214 from the physical worksite 102 that can be included in the worksite map 206. The perception-based localization and navigation system 150 can cooperate with the position/navigation system 160 to determine and assign geographic locations for the detected objects and worksite features. The use of current perception data and information 214 from the perception-based localization and navigation system 150 to generate and update the worksite map 206 advantageously incorporates changes and additions to the worksite features during the ongoing development of the physical worksite 102.

For example, in a specific embodiment, the map generator 202 can be programmed to conduct a simultaneous localization and mapping (SLAM) process to build a local version of the electronic map 206 by detecting the immediate surroundings as the mobile machine 100 navigates through the worksite 102. In the SLAM embodiment, the programming code and functionality of the map generator 202 may reside on the onboard electronic controller 140 of the mobile machine 100 and the generated computer-readable worksite map 206 may be local to the respective machine.

To determine the arrangement and relation of the worksite features 208 in the generated electronic worksite map 206, the map generator 202 can be associated with predefined mapping rules and definitions 216. The mapping rules and definitions 216 can be similar to an instruction set for the interpretation and arrangement of the survey data 210 and may be based upon standards and regulations. The mapping rules and definitions 216 can be maintained in the form of a data library or lookup table.

The map generator 202 can apply the mapping rules and definitions 216 to the survey data 210 to include the various worksite features 208 that characterize the physical worksite 102 as digital representations in the computer-readable worksite map 206. Worksite features 208 can include physical or material objects and elements, ongoing or intended operational activities, or relevant information associated with aspects about the physical worksite 102. For example, the worksite features 208 may include operation sites like the extraction sites 104 being excavated or the material piles 106 associated with the loading or dumping of material.

For navigation of the mobile machines 100, the worksite map 206 can also include the travel routes 108 including contextual information and details such as distances and direction. For example, a particular segment of the travel route 108 may be characterized as a straight, linear route segment, or straightaway 220. Another segment may be characterized by bends or route curves 222 causing directional changes in the travel route 108. As another example, a segment of the travel route 108 can be associated with an intersection 224 where a plurality of traveling mobile machines 100 may converge. Another example of a specific travel route segment can be a change in grade or slope 226 of the travel route 108 caused by an elevation change in the topology of the physical worksite 102.

The generated worksite map 206 can also include digital representations of the physical markers 154 in the physical worksite 102. The representations of the physical markers 154 in the worksite map 206 can be contextually associated with representative information about the status, size, spatial orientation, etc. about to the physical marker 154. Furthermore, the contextual or spatial association and/or relation between the physical markers 154 and the worksite features 208 assists in responding to those objects in the physical worksite 102.

For example, worksite personnel can place physical markers 154 at intended geographic locations and spatial positions or orientations about the physical worksite 102, and can enter the information to the worksite map 206 using the data entry terminals 212. The computer-readable worksite map 206 can reflect the spatial and contextual relation between the physical marker 154 and the worksite features 208. In some embodiments, stationary worksite features and objects such as geographic formations or structural buildings may be designated and employed as the physical markers 154.

In an embodiment, the map generator 202 can be configured to generate assigned marker positions 230 to assist in placement of the physical markers 154 with respect to the worksite features 208 in the electronic worksite map 206. In other words, the map generator 202 may consider the presence or absence of worksite features 208 in determining the placement of assigned marker positions 230. For example, the map generator 202 can retrieve and apply the mapping rules and definitions 216 to the identified worksite feature 208 to develop an assigned marker position 230 for the physical marker 154 with respect to a worksite feature 208. The mapping rules and definitions 216 can include the spatial proximity between the physical marker 154 and the worksite feature 208, and may output indications to enhance visibility of the physical marker such as rules for elevation or geometric size and shape of the physical marker. Based on the mapping rules and definitions 216, the map generator 202 can determine an assigned marker position 230 with respect to the worksite feature 208 that is intended to enhance the visibility and perceptibility of the physical marker 154 in the physical worksite 102.

For example, if the worksite feature 208 corresponds to a straightaway 220, the mapping rules and definitions 216 may produce assigned marker positions 230 that direct or suggest that the physical markers 154 should be placed to the right hand side of the travel route 108. The right hand location may be intended to place the physical marker 154 within the field of view of a perception device, such as the LIDAR device 152 or the smart camera 156, mounted to the mobile machines 100.

As another example, if the worksite feature 208 corresponds to a route curve 222, the mapping rules and definitions 216 can produce assigned marker positions 230 that locate the physical markers 154 parallel to and on the far side of the route curve 222 to effectively guide the mobile machine 100 through operation of the perception-based localization and navigation system 150. If the worksite feature 208 corresponds to a grade or slope 226, the mapping rules and definitions 216 can position physical markers 154 at the top and bottom of the grade or slope so that the perception devices can recognize the physical markers before encountering the grade or slope.

The worksite features 208 may affect the quantity or number of assigned marker positions 230 generated by the map generator 202. For example, if the worksite feature 208 is a route curve 222, as compared to a straightaway 220, the map generator 202 may increase the quantity of assigned marker positions 230, and thus the corresponding number of physical markers 150 in the worksite 102, so that the perception-based localization and navigation system 150 can better resolve location and navigate the route curve with greater accuracy.

In an aspect, the mapping application 200 can be configured to avoid or resolve visible or perceptive obstruction of the physical markers 154. Navigation and travel of the mobile machines 100 can be negatively impacted if a physical marker 154 becomes obstructed and is no longer perceptible to the perception-based localization and navigation system 150. As stated above, the mapping rules and definitions 216 may be configured to produce the assigned marker positions 230 to enhance visibility of the physical marker 154 to avoid or resolve marker obstructions.

In a further embodiment, to improve marker visibility, the mapping rules and definitions 216 can establish and define spatial or geometric control zones 232 or exclusions zones that are associated with the assigned marker positions 230 for the physical marker 154 in the worksite map 206. The control zones 232 provide an indication of the spatial area and locations within the worksite map 206 in which objects may perceptibly obstruct the physical marker 154, and therefore placement of an object within the control zones 232 should be avoided. The control zones 232 can be digital representations of spatial boundaries proximate to the assigned marker positions 230 and may have any suitable shape or geometry.

In the illustrated embodiment, the control zone 232 can be circular with the assigned marker position 230 as the center point. The radius and geometric position of the circular control zone 232 can be variably adjusted based upon factors such as the surrounding topography and environment of the physical worksite, the associated worksite features 208, and in an embodiment machine factors 234 associated with the plurality of mobile machines 100 operating at the worksite 102.

For example, the map generator 202 can be configured to receive and analyze different worksite features 208 including topography in developing the geometry of the control zones 232. Through analysis of the survey data 210, the map generator 202 can detect and classify the worksite features 208 and the mapping rule and definitions 216 can deterministically provide a geometry and/or spatial arrangement of the control zone 232 for the corresponding assigned marker position 230 to enhance perceptibility of the physical marker 154.

The map generator 202 can further receive or access data and information associated with the configuration and activities of the plurality of mobile machines 100 operating at the worksite. The machine factors 234 can include the configuration of the perception-based localization and navigation system 150 on the mobile machines 100, such as placement, e.g., height, elevation, or orientation, of the perception devices mounted on the machine frames or the resolution and/or sensitivity of the LIDAR devices 152 or smart cameras 156. The machine factors 234 can also include expected traffic presence of other mobile machines within the vicinity of the assigned marker position 230.

The map generator 202 utilizes the characteristics obtained about the worksite features 208 and the machine factors 234 to develop the control zone 232 with an area and geometry appropriate for the assigned marker positon 230. For example, the map generator 202 may determine to shift the control zone 232 associated with an assigned marker position 230 toward a worksite feature 208 such as the straightaway 220 or route curve 222. The shifted position of the control zone 232 therefore may more appropriately align with the expected travel routes 108 and location of the plurality of mobile machines 100 and/or worksite personnel 176 at the physical worksite 102.

The map generator 202 may adjust the shape and directionality of the control zone 232, for example, directing the control zone 232 toward oncoming traffic, or to exclude areas where traffic, and thus the presence of mobile machines with perception-based localization and navigation systems, is unlikely. For example, if the physical marker is adjacent a berm or wall, traffic will not approach the marker from that direction. As shown in FIG. 2, the map generator 202 may shape the control zone 232 to have a three-dimension arc or cone shaped geometry directed toward a route curve 222 where a mobile machine 234 may be traveling and away from a berm 236 where traffic is unlikely.

The analytic map processor 204, which receives and utilizes the generated worksite map 206 embodied, for example, as a digital image file, can also be programmed with features and routines to enhance visibility of the physical marker 154 in the worksite 102, specifically by identifying and resolving marker obstructions. The functionality for resolving marker obstructions may reside on the onboard electronic controllers 140 associated with the mobile machines, the central worksite server 180 located offboard and remote from the mobile machines, or may be distributed between them

In an embodiment, the analytic map processor 204 can include a marker identification module/routine 240 for identifying an assigned marker position 230 within the computer-readable worksite map 206 for further analysis. For example, the marker identification module/routine 240 can include or comprise an identification algorithm that processes the worksite map 206 to isolate the assigned marker position 230 that corresponds to a physical marker 154 in the physical worksite 102. The physical marker 154 may be one that the analytic map processor 204 is situated to gather additional information about to determine and resolve an associated marker obstruction. For example, the spatial proximity of a physical marker 154 to a particular mobile machine 100 may be the basis by which the marker identification module/routine 240 selects an assigned marker position 230 for analysis.

To determine if the physical marker 154 corresponding to the identified assigned marker position 230 is perceptibly obstructed, the analytic map processor 204 can include a detection module/routine 242. The detection module/routine 242 is responsible for gathering data and facts associated with the identified assigned marker position 230 which can be compared, contextualized, and analyzed to conclude if a marker obstruction exists. Furthermore, the data and facts gathered by the detection module/routine 242 can be obtained from intrinsic sources and/or extrinsic sources.

For example, the detection module/routine 242 can include a data gathering submodule/subroutine 244 that is configured to conduct operations to gather and obtain worksite data 246. Worksite data 246 can be data and facts that are affiliated with or related to the physical marker 154 in the worksite 102 and/or the assigned marker position 230 from the computer-readable worksite map 206. Worksite data 246 can be obtained from different physical sources such as the physical worksite 102 and virtual sources such as the worksite map 206.

Worksite data 246 can therefore be intrinsic worksite data 248 and/or an extrinsic worksite data 249. Intrinsic worksite data 248 may be intrinsically residing with or associated with the mapping application 200. An example of intrinsic worksite data 248 can be the control zones 232 associated with the assigned marker positions 230, which can be obtained from the computer-readable worksite map 206. The data gathering submodule/subroutine 244 can select and extract the intrinsic worksite data 248 from analysis of the worksite map 206.

Extrinsic worksite data 249 can be obtained from sources extrinsic or external to the analytic map processor 204, for example, data and information associated with and obtained from or about the physical worksite 102. For example, the perception devices such as the LIDAR device 152 and/or the smart camera 156 of the perception-based localization and navigation system 150 can capture perception data 250 from the physical worksite 102.

Extrinsic worksite data 249 can also include location/position data 252 about the geographic location of the mobile machine 100 with respect to the physical worksite 102 as obtained from the position/navigation system 160. Other possible sources of extrinsic worksite data 249 can be data and facts communicated to the data gathering submodule/subroutine 244 from the central worksite server 180 via the telematics system 188, data and facts communicated from other mobile machines 100 using the machine transceivers 174, and/or worksite personnel 176 using personnel transceivers 178.

The detection module/routine 242 also includes a data analysis submodule/subroutine 254 that conducts analytic tasks on the data set, including the intrinsic and extrinsic worksite data 248, 249 collected about the assigned marker position 230 and the corresponding physical marker 154 in the worksite 102. The data analysis submodule/subroutine 254 can execute various computer actuated operations and tasks on the gathered worksite data 246 to determine if the physical marker 154 is perceptibly obstructed and thus the occurrence of a marker obstruction. For example, the data analysis submodule/subroutine 254 may determine from the perception data 250 that the physical marker 154 is not actually present at the location indicated by an assigned marker position 230 in the worksite map 206. As another example, the data analysis submodule/subroutine 254 can assess the proximity of various objects with respect to the physical markers 154 and the resulting effect on perceptibility.

If the data analysis submodule/subroutine 254 determines a marker obstruction has occurred, the analytic map processor 204 can include an obstruction resolution module/routine 260 that is programmed to resolve or remedy the perceptible obstruction of the physical marker 154. The obstruction resolution module/routine 260 can output an obstruction resolution 262 that may be in the form of a transmittable data signal. The obstruction resolution 262 may include instructions or directions for resolving the marker obstruction. Examples of obstruction resolutions 262 include updates to the worksite map 206 and operational directions to the mobile machines 100 and/or worksite personnel 176.

### INDUSTRIAL APPLICABILITY

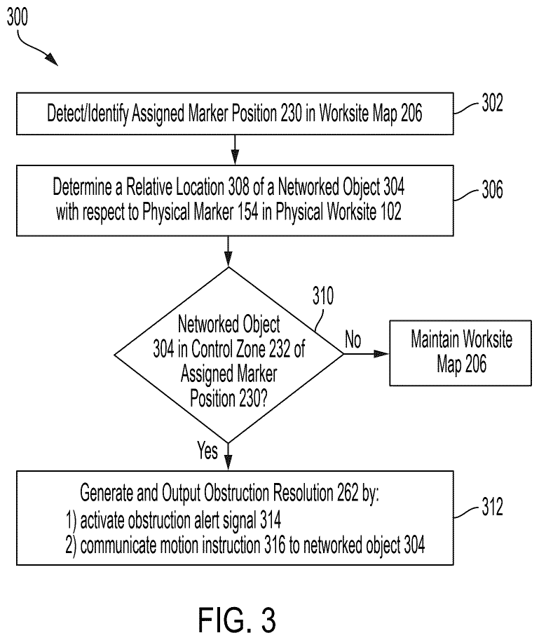

Referring to FIGS. 3, 4, and 5, with continued reference to the preceding figures, there are illustrated embodiments of methods and techniques for identifying and resolving various obstructions that may be interfering with the perceptibility or visibility of physical markers 154 that would detrimentally impact operation of the perception-based localization and navigation systems 150 of the plurality of mobile machines 100. In accordance with the disclosure, the plurality of mobile machines 100 can be operated autonomously, semi-autonomously, or manually at the worksite 102.

The methodologies, which are represented as sequentially flow diagrams of possible events or actions, can be implemented as non-transitory, computer-executable software programs written in any suitable programming language and run on any suitable computer architecture utilizing one or more processors and peripheral devices. Accordingly, the programming code and the corresponding operations may be distributed between the onboard electronic controllers 140 of the mobile machines 100, the offboard central worksite server 180, and possibly other computer and electronic systems associated with the physical worksite 102.

For example, as illustrated in FIG. 3, an obstruction detection method 300 can be initiated with a marker detection/identification operation 302 that is conducted by the marker identification module/routine 240 of the analytic map processor 204 that, as indicated, may be local to the onboard electronic controllers 140 associated with the mobile machines 100 or may reside offboard on the central worksite server 180. The detection/identification operation 302 is applied to the worksite map 206 to identify an assigned marker position 230 for further analysis, and the computer-readable worksite map 206 can be system or enterprise wide copy saved on the central worksite server 180 or a local copy saved on the onboard electronic controller 140.

Identification of a particular assigned marker position 230 may be based upon proximity of a mobile machine 100 or worksite personnel 176 to a physical marker 154 in the worksite 102. The mobile machine 100 or worksite personnel 176 can be communicatively networked with the analytic map processor 204 and thus can gather and transfer data and information about the physical marker 154 in furtherance of the obstruction detection method 300. The mobile machine 100 and the worksite personnel 176 are thus networked objects 304 for the obstruction detection method 300.

In an embodiment, the obstruction detection method 300 may be configured to determine if a networked object 304 may be the cause of the perception obstruction with respect to the physical marker 154. The obstruction detection method 300 may include a location operation 306 which determines the relative location 308 of the networked object 304 with respect to the physical marker 154 that corresponds to the assigned marker position 230 previously identified for analysis. To determine the relative location 308, the location operation 306 can use the position/navigation system 160 that can be associated with the mobile machine 100 and/or worksite personnel 176.

In another embodiment, to determine the relative location 308 of the networked object 304, the perception-based localization and navigation system 150 associated with a mobile machine 100 can be used by the location operation 306. For example, the LIDAR device 152 or the smart camera 156 mounted on the mobile machine 100 can function as a range finder, thereby finding the spatial distance or range between the mobile machine 100 and the physical marker 154.

To determine if the physical marker 154 is possibly obstructed, the obstruction detection method 300 may conduct an obstruction decision 310 in which the relative location 308 of the networked object 304, determined by the location operation 306, is compared with the assigned marker position 230 obtained from the worksite map 206. The obstruction decision 310 determines the relative positions and spatial proximity of the physical marker 154 and the networked object 304 that may be indicative of a marker obstruction. For example, the obstruction decision 310 can determine if the networked object 304 is geographically located within the area defined by the control zone 232 associated with the assigned marker position 230 and obtained from the worksite map 206.

If the obstruction decision 310 determines the networked object 304 is not within the control zone 232, and therefore is not likely perceptibly obstructing the physical marker 154, the obstruction detection method 300 can maintain the worksite map 206 as is. If the networked object 304 may be obstructing the physical marker 154, the obstruction detection method 300 can include and proceed to a resolution operation 312 to attempt to resolve the marker obstruction. The resolution operation 312 can be conducted by the obstruction resolution module/routine 260 of the analytic map processor 204.

An example of an obstruction resolution 262 that may be generated by the resolution operation 312 can include activating an alarm device that may communicate an obstruction alert signal 314. The obstruction alert signal 314 can be a visible or audible signal that may be generated and output by the HMI 170 onboard the mobile machine 100 or a similar device carried by the worksite personnel 176. Another example of an obstruction resolution 262 can be a motion instruction 316 or direction for the networked object 304 to move relative to the physical marker 154. If the networked object 304 is a mobile machine 100, the motion instruction 316 can result in the mobile machine engaging its ground-engaging traction devices to move out of proximity with respect to the physical marker 154 and thus out of the control zone 232 thereby eliminating the marker obstruction.

The resolution operation 312 may be configured to consider the identity of the networked object 304 in generating the objection resolution 262. For example, an objection alert signal 314 may be appropriate to resolve marker obstructions associated with manually operated mobile machines 100 and/or worksite personnel 176. The alert signal 314 may visually indicate on an HMI the relative position of the networked object 304 and the physical marker and 154 and indicate that the networked object should move or otherwise resolve the obstruction. However, a more specific motion instruction 316 clearly directing or initiating movement may be necessary to resolve an obstruction associated with autonomous mobile machines 100, in which there is no operator to respond to an alert signal 314. The determination step 306 may include functionality to determine and identify the type of networked object 304 for consideration by the resolution operation 312 in generating the obstruction resolution 262.

In an embodiment, the obstruction decision 310 and/or the resolution operation 312 may account for a temporal delay or time sensitivity. For example, the obstruction decision 310 may monitor or assess how long the networked object 304 is present within the control zone 232, and may only proceed to obstruction resolution 312 after a predetermined period to allow the obstruction created by the networked object to resolve itself. The resolution operation 312 may also include delays before initiating a particular resolution.

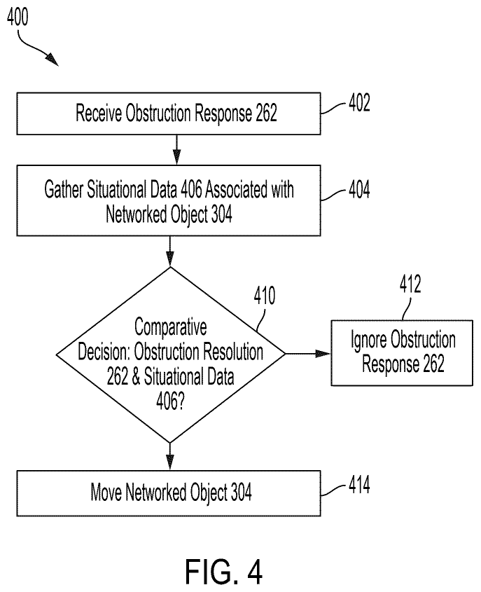

Referring to FIG. 4, the networked object may be configured to conduct a further evaluation to determine if it is appropriate to act upon the obstruction resolution 262 resulting from the obstruction detection method 300. The resolution evaluation 400 can be performed locally by the networked object 304, for example, by the onboard electronic controller 140 of the mobile machine 100. Local execution of the resolution evaluation 400 can occur in embodiments where the obstruction detection method 300 is conducted remotely by the central worksite server 180 or onboard by the electronic controller 140. Alternatively, the resolution evaluation 400 or aspects thereof may occur offboard at the central network server 180 or at another location, which may be advantageous for example in the case of autonomous mobile machines.

The resolution evaluation 400 can be initiated through a resolution reception step 402 in response to receiving the obstruction resolution 262 communicated from the resolution operation 312 as either a remote communication or a local transmission. To assess and evaluate the obstruction resolution 262, the resolution evaluation 400, in a data-gathering step 404, can gather situational data 406 about the present operating situation associated with the networked object 304.

Examples of situational data 406 can include data from the machine sensors 168 that indicate the operating situation of the mobile machine 100, such as whether it is moving, stationary, or engaged in an operation or performing a task. Another example of situational data 406 can be perception data and information about the environmental surroundings proximate the mobile machine 100 captured by the perception-based localization and navigation system 150. The situational data 406 can indicate the presence of other mobile machines 100, worksite personnel 176, and the ongoing activities proximate the mobile machine 100 evaluating the obstruction resolution 262.

The resolution evaluation 400 can conduct a comparative decision 410 to determine whether to respond in accordance with the obstruction resolution 262. For example, the comparative decision 410 can compare the obstruction resolution 262 with the situational data 406. If the comparative decision 410 determines compliance with the obstruction resolution 262 is not feasible or may be detrimental, the resolution evaluation 400 results in a conclusion 412 to ignore the obstruction resolution 262. For example, the situational data 406 can indicate the mobile machine 100 is already moving and will exit the control zone 232, or that the mobile machine 100 is conducting a worksite operation and moving is not feasible. The situational data 406 may indicate that other machines or worksite personnel are present and the comparative decision 410 may determine that moving the networked object, if a mobile machine, could be hazardous.

In another example, the situational data 406 may be associated with the importance of the physical marker 154. For example, if the physical marker 154 is remote and/or seldom utilized by other perception-based localization and navigation systems, the obstruction resolution 262 may be unnecessary or impractical and the comparative decision 410 can result in a conclusion 412 to ignore obstruction resolution. If the physical marker 154 is important, for example, if located at a high traffic intersection or the like, the comparative decision 410 can expedite the obstruction resolution 262.

If the comparative decision 410 determines the situational data 406 does not preclude or otherwise prevail with respect to the obstruction resolution 262, the resolution evaluation 400 can result in compliance 414 with the obstruction resolution 262. For example, the mobile machine 100 can engage the traction devices to move out of proximity with respect to the physical marker 154 and thus out of the control zone 232. The perception-based localization and navigation system 150 and the position/navigation system 160 can assist in moving the mobile machine 100 to eliminate the marker obstruction.

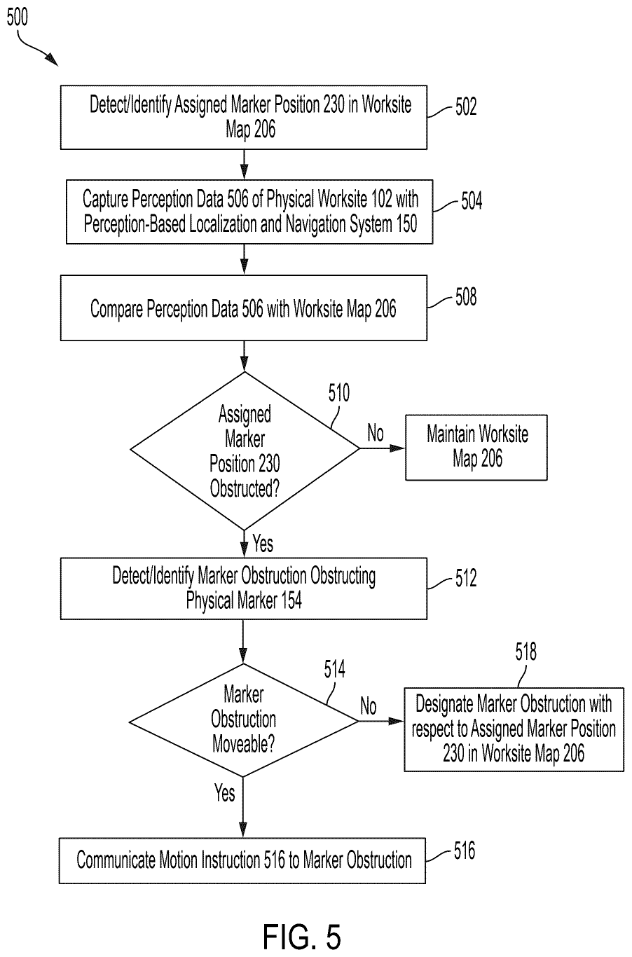

Referring to FIG. 5, in another embodiment, the methodology for identifying and resolving marker obstructions may utilize the perception-based localization and navigation system 150. For example, an obstruction detection method 500 can be initiated by a marker detection/identification operation 502, which may be conducted by the marker identification module/routine 240 of the analytic map processor 204. The marker detection/identification operation 502 can identify an assigned marker position 230 within the worksite map 206 for further analysis based upon, for example, proximity within the physical worksite 102 of the corresponding physical marker 154 to a mobile machine 100 equipped with a perception-based localization and navigation system 150.

The obstruction detection method 500 can conduct a perception data capture step 504 to capture perception data 506 with the perception-based localization and navigation system 150. For example, the LIDAR device 152 or smart camera 156 may be used to capture the perception data 506. If geographic location of the mobile machine 100 corresponds with the assigned marker position 230 in the worksite map 206, the perception data 506 presumably should include the physical marker 154.

To determine if the physical marker 154 is obstructed, a comparison operation 508 compares the perception data 506 with the worksite map 206 and specifically with respect to the assigned marker position 230. In an obstruction decision 510, the obstruction detection method 500 can confirm or refute the existence of a marker obstruction based on the comparison operation 508. If the obstruction decision 510 determines there is no marker obstruction with respect to the physical marker 154, the obstruction detection method 500 can maintain the worksite map 206 as is. Alternatively, if the comparison operation 508 indicates the absence of a physical marker 154 in the captured perception data 506, contrary to a corresponding assigned marker position 230 in the worksite map 206, the obstruction decision 510 can conclude the physical marker 154 is perceptibly obstructed.

To the resolve the cause of the obstruction, the obstruction detection method 500 can attempt to identify the marker obstruction in an obstruction identification operation 512. For example, the obstruction identification operation 512 can analyze the perception data 506 using an object detection and classification algorithm to identify objects in the physical worksite 102 proximate to the assigned marker position 230.

If an object is detected, the obstruction detection method 500 can attempt to resolve the marker obstruction by, for example, deciding in a resolution decision 514 if the marker obstruction can be moved. The resolution decision 514 can be conducted by the obstruction resolution module/routine 260 to determine the appropriate obstruction resolution 262 to output with respect to the identified marker obstruction.

If the marker obstruction is movable, for example, if the marker obstruction is a mobile machine 100 parked proximate to the physical marker 154, the obstruction detection method 500 can result in a motion instruction 516 or direction commanding the mobile machine 100 to move out of proximity with respect to the physical marker 154. The motion instruction 516 can be communicated to the mobile machine 100, which may conduct the resolution evaluation 400 described in FIG. 4 as to whether to comply.

If the marker obstruction is not movable, for example, if the identified marker obstruction is overgrowth or a structural construction, then the obstruction detection method 500 conducts a designation operation 518 that designates the marker obstruction in the worksite map 206. For example, the analytic map processor 204 can designate the assigned marker position 230 within the worksite map 206 as obstructed by the marker obstruction, and can communicate or broadcast the updated worksite map 206 for the benefit of mobile machines 100 and worksite personnel 176 at the worksite 102. The designation operation 518 can be associated with re-routing of the mobile machines about the worksite, due to the unavailability of the obstructed physical marker, or other can result in other changes to fleet management.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A computer-implement analytic map processor comprising:
a marker identification module to identify an assigned marker position in a worksite map in a computer readable format;
a data gathering module to obtain worksite data;
a detection module configured to analyze the worksite data with respect to the assigned marker position identified by the marker identification module to determine if a marker obstruction has occurred that perceptibly obstructs a physical marker corresponding to the assigned marker position; and
an obstruction resolution module configured to determine and output an obstruction resolution in response to the marker obstruction.

2. The analytic map processor of claim 1, wherein the worksite data is one or more of intrinsic worksite data and extrinsic worksite data.

3. The analytic map processor of claim 2, wherein the intrinsic worksite data is a control zone associated with the assigned marker position obtained from the worksite map.

4. The analytic map processor of claim 3, wherein the extrinsic worksite data is a relative location of a networked object with respect to the physical marker.

5. The analytic map processor of claim 4, wherein the relative location of the networked object is determined from a position/navigation system.

6. The analytic map processor of claim 4, wherein the relative location of the networked object is determined from a perception-based localization and navigation system associated with the networked object.

7. The analytic map processor of claim 4, wherein the marker obstruction corresponds to the relative location of the networked object matching the control zone associated with the assigned marker position.

8. The analytic map processor of claim 1, wherein the worksite data is perception data obtained by a perception-based localization and navigation system associated with a mobile machine.

9. The analytic map processor of claim 8, wherein the detection module compares the perception data with the assigned marker position from the worksite map to determine if the marker obstruction has occurred.

10. The analytic map processor of claim 1, wherein the detection module is configured to determine if the marker obstruction is movable.

11. The analytic map processor of claim 10, wherein the obstruction resolution is a motion instruction communicated from the obstruction resolution module to the marker obstruction.

12. A computer-implemented method for detecting and resolving a marker obstruction of a physical marker at a physical worksite comprising:
identifying an assigned marker position in a worksite map in a computer-readable format;
obtaining worksite data from one or more of the physical worksite and the worksite map;
analyzing the worksite data and the worksite map to determine if a mark obstruction has occurred that perceptibly obstructs the physical marker; and
determining an obstruction resolution to resolve the marker obstruction.

13. The method of claim 12, wherein the obstruction resolution is one or more of a motion instruction and a marker obstruction designation updated to the worksite map.

14. The method of claim 12, wherein the step of analyzing the worksite data comprises comparing a control zone associated with the assigned marker position and a relative location of a networked object with respect to the physical marker.

15. The method of claim 14, wherein the relative location of the networked object is determined from one or more of a position/navigation system associated with the networked object and a perception-based localization and navigation system associated with the networked object.

16. The method of claim 12, wherein the step of analyzing the worksite data compares perception data obtained from a perception-based localization and navigation system with the assigned marker position from the worksite map.

17. The method of claim 12, further comprising:
obtaining situational data regarding a networked object; and
comparing the obstruction resolution with the situational data to evaluate compliance with the obstruction resolution.

18. The method of claim 17, wherein the networked object is a mobile machine configured for autonomous operation.

19. An onboard electronic controller associated with a mobile machine operating at a physical worksite that is configured with a perception-based localization and navigation system, the onboard electronic controller comprising:
memory storing a worksite map in computer-readable format and including an assigned marker position;
a data gathering module configured to obtain worksite data from one or more of the physical worksite and the worksite map; and
a detection module configured to analyze the worksite map and the worksite data to determine if a physical marker in the physical worksite, corresponding to the assigned marker position, is perceptibly obstructed.

20. The onboard electronic controller of claim 19, further comprising an obstruction resolution module configured determine and output an obstruction resolution in response to determining the physical marker is perceptibly obstructed.
